(19) United States
(12) Patent Application Publication
(10) Pub. No.: US 2015/0150013 A1
(43) Pub. Date: May 28, 2015

(54) REDUCING JOB CREDENTIALS MANAGEMENT LOAD

(71) Applicant: International Business Machines Corporation, Armonk, NY (US)

(72) Inventors: Chen Chong, Markham (CA); Zhaohui Ding, Beijing (CN); Fang Liu, Beijing (CN); Sam Sanjabi, Torontoi (CA); Rongsong Shen, Beijing (CN); Shuai Jie Wang, Beijing (CN)

(73) Assignee: International Business Machines Corporation, Armonk, NY (US)

(21) Appl. No.: 14/089,312

(22) Filed: Nov. 25, 2013

(51) Int. Cl. G06F 9/46

(52) U.S. Cl. CPC G06F 9/468
USPC 718/102

(57) ABSTRACT

A method, system, and computer program product for reducing job credentials management load are provided in the illustrative embodiments. A determination is made whether a credential data submitted with a job matches a second credential data stored in a repository, the credential data comprising a set of attributes. Responsive to the credential data matching the second credential data, a reference to the second credential data is associated with the job. The second credential data is updated to enable the job for execution. The job is forwarded with the reference to a receiver application, wherein the reference provides the receiver application an authorization to execute the job.

### TECHNICAL FIELD

The present invention relates generally to a method, system, and computer program product for managing job scheduling and execution in data processing system clusters. More particularly, the present invention relates to a method, system, and computer program product for reducing job credentials management load in data processing environments.

### BACKGROUND

A computational workload for executing on a data processing system is referred to as a job. A user or an application (hereinafter, a “submitter”) can submit a job for execution on a data processing system.

A cluster or a clustered data processing environment is essentially a group of data processing systems (nodes) managed by a single workload manager. A cluster workload manager receives a job from a submitter, and determines when and on which cluster node to execute the job.

### SUMMARY

The illustrative embodiments provide a method, system, and computer program product for reducing job credentials management load. An embodiment includes a method for reducing job credentials management load. The embodiment determines, at a first application using a processor and a memory, whether a credential data submitted with a job matches a second credential data stored in a repository, the credential data comprising a set of attributes. The embodiment associates, responsive to the credential data matching the second credential data, a reference to the second credential data with the job. The embodiment updates the second credential data to enable the job for execution. The embodiment forwards the job with the reference to a receiver application, wherein the reference provides the receiver application an authorization to execute the job.

Another embodiment includes a computer usable program product comprising a computer usable storage device including computer usable code for reducing job credentials management load. The embodiment further includes computer usable code for determining, at a first application using a processor and a memory, whether a credential data submitted with a job matches a second credential data stored in a repository, the credential data comprising a set of attributes. The embodiment further includes computer usable code for associating, responsive to the credential data matching the second credential data, a reference to the second credential data with the job. The embodiment further includes computer usable code for updating the second credential data to enable the job for execution. The embodiment further includes computer usable code for forwarding the job with the reference to a receiver application, wherein the reference provides the receiver application an authorization to execute the job.

Another embodiment includes a data processing system for reducing job credentials management load. The embodiment further includes a storage device including a storage medium, wherein the storage device stores computer usable program code. The embodiment further includes a processor, wherein the processor executes the computer usable program code. The embodiment further includes computer usable code for determining, at a first application using a processor and a memory, whether a credential data submitted with a job matches a second credential data stored in a repository, the credential data comprising a set of attributes. The embodiment further includes computer usable code for associating, responsive to the credential data matching the second credential data, a reference to the second credential data with the job. The embodiment further includes computer usable code for updating the second credential data to enable the job for execution. The embodiment further includes computer usable code for forwarding the job with the reference to a receiver application, wherein the reference provides the receiver application an authorization to execute the job.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for reducing job credentials management load in accordance with an illustrative embodiment;

FIG. 4 depicts a block diagram of a configuration for reducing job credentials management load in accordance with an illustrative embodiment;

FIG. 5 depicts a flowchart of an example process for reducing job credentials management load in accordance with an illustrative embodiment; and

FIG. 6 depicts a flowchart of another example process for reducing job credentials management load in accordance with an illustrative embodiment.

### DETAILED DESCRIPTION

A job requires a combination of hardware and software resources to execute. A scheduling application, e.g., a cluster workload manager, schedules the job for execution on the selected data processing system or node at a scheduled time or when the resources needed for executing the job can be scheduled on that data processing system or node.

Under certain circumstances, one data processing system can receive a job, and can send the job to another data processing system for execution. For example, a cluster workload manager can send a job to another cluster workload manager for execution in another cluster.

Within the scope of the illustrative embodiments, any software application or firmware, which receives a job from a submitter and sends the job for execution on a data processing system, is referred to as a manager agent. In some implementations, the manager agent can take the form of a job scheduler or an equivalent thereof. In certain other implementations, the manager agent can take the form of a cluster workload manager or an equivalent thereof.

Within the scope of the illustrative embodiments, a data processing system of any type that a manager agent can use for executing a job is referred to as a node. In a node, a software application or firmware, which receives a job from a manager agent and causes the execution to be performed at the node, is referred to as an execution agent.

The manager agent and the execution agent can operate on same or different nodes within the scope of the illustrative embodiments. For example, when a node is a stand-alone computer, the manager agent and the execution agent can operate on the same stand-alone computer. As another example, when the node is a computing node in a clustered data processing environment, the manager agent and the execution agent can, and usually do, operate on different nodes of a cluster.

The illustrative embodiments recognize that under many circumstances a job has to be authenticated before the job can execute or use certain computing resources. For example, a job may need access to a system service, which requires the authentication.

The illustrative embodiments further recognize that authenticating a job uses certain credentials to be associated with the job. Presently, a submitter's credential, e.g., the credentials of a user, is used as the job credential for authenticating the job scheduled by that submitter. Kerberos is an example authentication system that provides credentials that can be associated with a job.

The illustrative embodiments recognize that an authentication credential can be role-specific. For example, a submitter's credential, which is associated with a job submitted by the submitter, is associated with a particular role of the submitter in the cluster. For example, a user may submit jobs as multiple roles depending on the nature of the jobs and the service permissions they require. The illustrative embodiments recognize that a job must have associated therewith credentials sufficient to obtain the computing resources that the job needs for successful execution.

The illustrative embodiments further recognize that the credential has to be valid when the job is to be executed. The illustrative embodiments recognize that some jobs can wait in a queue for a period longer than a validity period of the authentication credentials associated with the job. Thus, the illustrative embodiments recognize that a job must carry the authentication credentials throughout the job's life cycle—when submitted, while waiting for scheduling, and while executing.

The illustrative embodiments further recognize that authentication credentials associated with a job are typically configured to expire after a short period of time unless explicitly renewed by the owner—submitter—of the job. Short expiry of authentication credentials helps to limit credentials' abuse and increases system security. The illustrative embodiments recognize that a manager agent maintaining these credentials for each pending job has to periodically renew them for each job in a queue or during execution, so that the credentials a job requires to access certain resources remain valid throughout the job's execution.

The illustrative embodiments further recognize that the size of modern clusters has been increasing rapidly. For example, a high-demand commercial cluster can include ten thousand or more nodes, each node including thirty two to sixty four processor cores, and processing tens of millions of concurrently managed pending and running jobs. Thus, the illustrative embodiments recognize that managing authentication credentials on a job-by-job basis for millions of individual jobs can quickly become a major bottleneck in authentication services, workload management, or a combination thereof, in large-scale commercial data processing environments.

The illustrative embodiments recognize that some presently available job authentication methods associate a user's credentials, such as a user-ID and/or password with the jobs the user submits. The illustrative embodiments recognize that often different jobs by the same user require different access privileges for different computing resources, and associating a single user-credentials with the jobs is not sufficient in a complex structured data processing environment.

The illustrative embodiments also recognize that some other presently available job authentication methods further manage each credential associated with each job individually. Such methods are undesirable for the reasons of scalability in large data processing environments, as described above.

The illustrative embodiments used to describe the invention generally address and solve the above-described problems and other problems related to authenticating job credentials in a data processing environment. The illustrative embodiments provide a method, system, and computer program product for reducing job credentials management load in a data processing environment.

An embodiment associates an authentication credential with a job. The authentication credential according to an embodiment need not be associated with a user or an application. For example, job-specific credentials created specifically for associating with one or more particular jobs to cause successful execution of those one or more jobs are contemplated within the scope of the illustrative embodiments.

In one embodiment, a master agent determines whether a credential received with a new job is already associated with another job in the system, e.g., another job that is currently awaiting execution or is currently executing within the domain of the master agent. Within the scope of the illustrative embodiments, a domain of a master agent includes but is not limited to a cluster or a data processing system where the master agent is operating. For example, as described elsewhere in this disclosure, a master agent can forward a job to another master controller of another cluster for execution in the other cluster. Accordingly, the domain of a master controller comprises the set of jobs managed by master agent, whether for execution in the data processing system or cluster where the master agent is operating or for execution in another data processing system or cluster to which the master agent can forward a job.

If the embodiment finds that the credential of the new job is already associated with another job presently existing in the domain, the embodiment replaces the credential of the new job with a reference to the credential of the other job. In one embodiment, the master agent hashes, using a suitable hashing algorithm, a subset of a set of attributes of the credentials associated with the jobs. The master agent compares the hash values to determine whether two credentials associated with two different jobs are the same. In such an embodiment, the master agent replaces the credential of the new job with a reference to the hash value of the credential of the other job existing in the domain.

In this manner, an embodiment saves the first instance of a new credential, and replaces future instances of the same credential with a reference to the saved credential. Within the scope of the illustrative embodiments, the saved credential can be the credential as presented by the job, a modified form of that credential, or a value computed from that credential, or a combination thereof.

In one embodiment, the master agent manages a count of credential use for each saved credential. For example, as a new job using the saved credential is received, the master agent replaces the credential with the reference to the saved credential, and increments a use count for the saved credential. When a job using the credential completes execution, the master agent decrements the use count for the saved credential. When the use count of a saved credential decrements to zero, an embodiment purges the saved credential such that a future job with the same credential will cause the credential to be saved anew for the saving, incrementing, replacing with reference, and decrementing operations to repeat in the manner described above.

At any given time, an embodiment thus manages a significantly smaller number of credentials as compared to the number of jobs existing in the domain. As a consequence, the embodiment has to monitor the expiration of fewer credentials, request fewer renewals from an external credential management authority, and thereby cause reduced network traffic and computational overhead for job authentication related workload.

The illustrative embodiments are described with respect to certain types of credentials, certain computations, certain credential management authorities, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

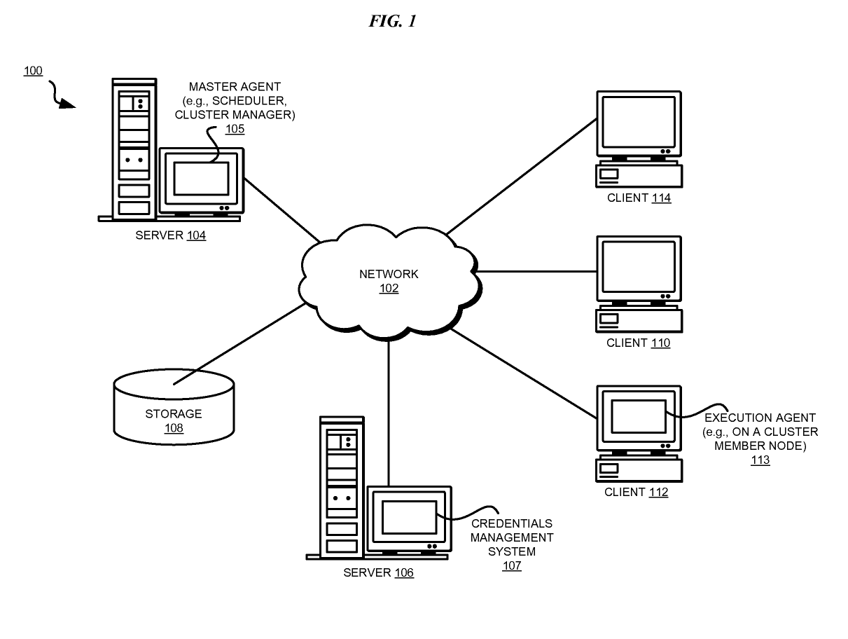

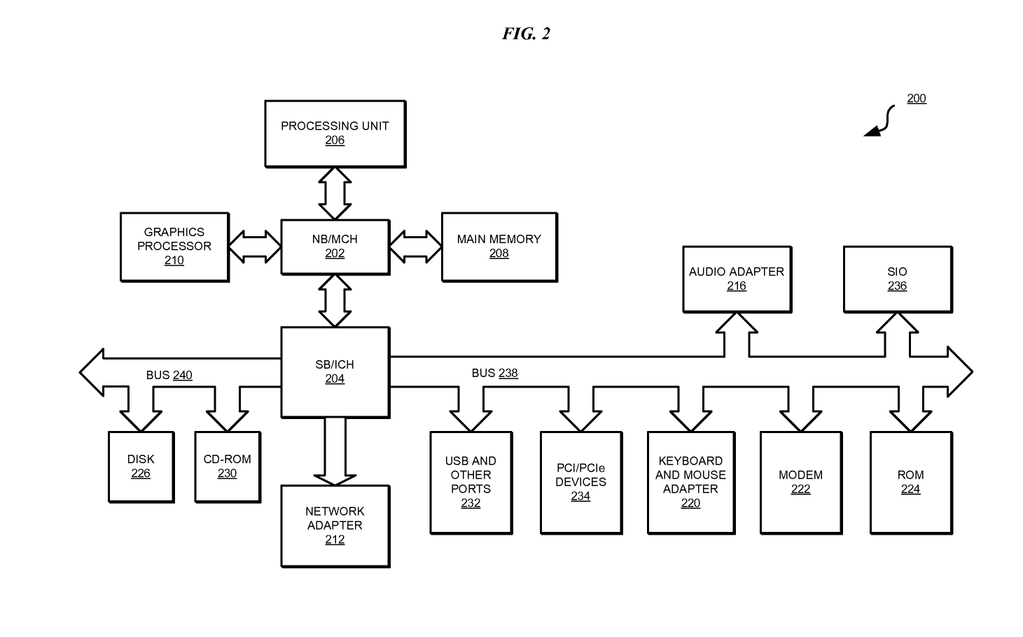

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are useable in an embodiment. Servers 104 and 106, and clients 110, 112, 114, are depicted as servers and clients only as example. Data processing systems 104, 106, 110, 112, and 114 also represent example nodes in a cluster and other configurations suitable for implementing an embodiment. In one embodiment, servers 104 and 106 are two partitions in a host. In another embodiment, servers 104 and 106 are distinct computer systems. As an example, server 104 includes master agent 105, which is improved with an embodiment described herein. Credential management system 107 is an external system for issuing, renewing, revoking, and validating a credential that can be associated with a job managed by master agent 105. In one embodiment, credential management system 107 is a third-party system, to wit, a system not under the control of a user or administrator of master agent 105. Furthermore, in one embodiment, credential management system 107 manages credentials that are unrelated to a user in data processing environment 100 and are created and managed according to the jobs to be processed in data processing environment 100. Execution agent 113 in data processing system 112 is an example execution agent that receives a job for execution from master agent 105.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as master agent 105, credential management system 107, and execution agent 109 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

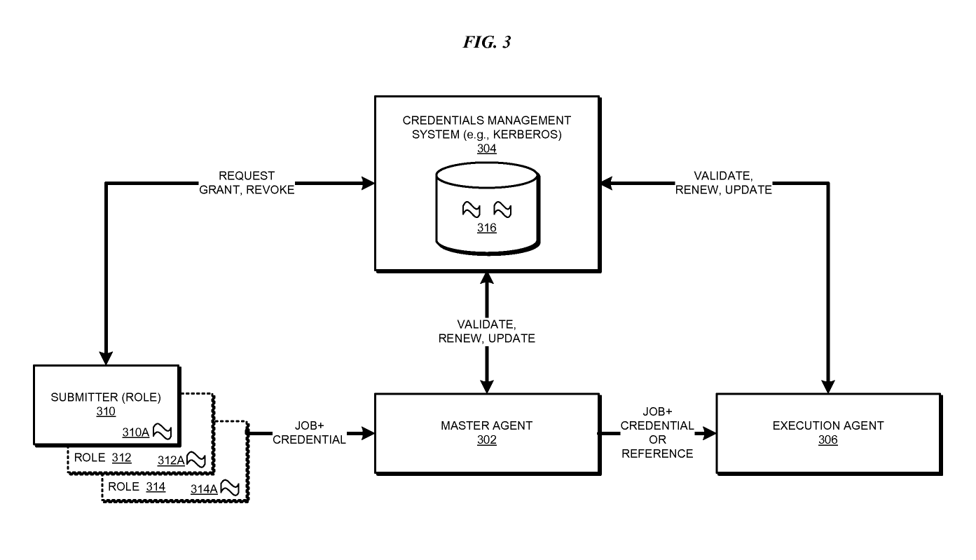

With reference to FIG. 3, this figure depicts a block diagram of an example configuration for reducing job credentials management load in accordance with an illustrative embodiment. Master agent 302 is an example of master agent 105 in FIG. 1. Credentials management system 304 is an example of credentials management system 107 in FIG. 1. Execution agent 306 is an example of execution agent 113 in FIG. 1.

Submitter 310 is any user or application submitter as described earlier. Submitter 310 can submit jobs in any of one or more roles of submitter 310, each role having different access privileges, authorizations, and credentials. For example, in one role, submitter 310 has associated therewith credential 310A, which allows a job submitted by submitter 310 in that role to have the authorizations allowed for credential 310A. Submitter 310 can also submit a job under any number of other roles, for example, role 312 using corresponding credential 312A or role 314 using corresponding credential 314A.

Submitter 310 or a role thereof can also obtain a credential specific to a job (not shown). For example, submitter 310 can specify a set of authorization parameters needed for executing a job successfully, the authorization parameters being unrelated to the identity of submitter 310 or role 312 or 314 thereof.

System 304 manages credentials using credentials repository 316. System 304 receives requests for credentials from submitter or roles 310-314. System 304 grants or issues one or more credentials responsive to the requests. System 304 also revokes or expires issued credentials according to any suitable factor. Some factors for expiring an issued credential include but are not limited to an elapsed period since the issuance, a change in a job status, a change in a requestor's status, a subsequent request, and an event in a data processing environment where the credential is used.

System 304 manages the state of the credentials using repository 316. For example, system 304 records all or some of the set of attributes of the credentials that are currently issued, revoked, expired, active, or otherwise existing in the data processing environment where submitter 310, master agent 302, execution agent 306, or a combination thereof are operating.

From time-to-time, master agent 302 determines whether a credential associated with a job received from submitter or role 310-314 is still valid, or will remain valid for some period. Periodically or upon an event, master agent 302 requests renewal or update of expired or expiring credentials associated with one or more jobs in the manner of an embodiment.

Master agent 302 sends a queued job for execution to execution agent 306. Master agent 302 sends the job with either a credential or a reference to a credential. For example, when master agent 302 determines that execution agent 306 has access to the credential, such as by having received and saved a credential from a job previously sent from master agent 302, master agent 302 sends the job with a reference to the previously sent credential. When master agent 302 determines that execution agent 306 does not have access to the credential, such as when master agent 302 has not sent the credential with a job previously, master agent 302 sends the job with the credential data.

In one embodiment, before sending a job to execution agent 306, master agent 302 queries execution agent 306 to determines whether execution agent 306 already hast the credential data of the job. If execution agent 306 responds that the credential data is available at execution agent 306, master agent 302 sends only a reference to the credential; otherwise, master agent 302 sends the job with the credential data. In another embodiment, master agent 302 always sends jobs with their credential data, and leaves the determination of storing new credential data or discarding existing credential data to execution agent 306.

In another embodiment, master agent 302 determines whether execution agent 306 has access to a credential by determining whether an elapsed time since the last sending of the same credential exceeds a threshold, whether a number of jobs sent since the last sending of the same credential exceeds a threshold, whether a job with which the credential was sent has completed execution, whether any use count remain for the credential, or a combination thereof. From this disclosure, those of ordinary skill in the art will be able conceive other similarly purposed techniques for determining whether to send the credential data or a reference to a credential, from master agent 302 to execution agent 306, and the same are contemplated within the scope of the illustrative embodiments.

Execution agent 306 also validates, renews, or updates the credentials of a job before and/or during the execution of the job. For example, if a job references a previously stored credential that is expired or about to expire within a threshold time period, execution agent 306 requests a renewal of the stored credential from system 304. Execution agent begins or continues the execution of the job subject to system 304 renewing or updating the stored credential to a currently valid state with authority sufficient to execute the job.

Certain interactions, messaging, and operations are described between master agent 302 and execution agent 306 to demonstrate the operation of an embodiment within a cluster. Operations across clusters are also included in the scope of the illustrative embodiments. Similar interactions, messaging, and operations are usable between a master agent in one cluster and a master agent in another cluster, when a job is passed from one cluster to another. Such across-clusters manner of using an interaction, messaging, or operation of an embodiment is contemplated within the scope of the illustrative embodiments.

Note that within the scope of the illustrative embodiment, the credential data associable with jobs is forwardable. In other words, the credential data is not system specific, not restricted for use on specific data processing systems in a cluster, can be passed from one system to another for storage, comparison, updates, and evaluation. In one embodiment, the credential data is forwardable in the form of a data file.

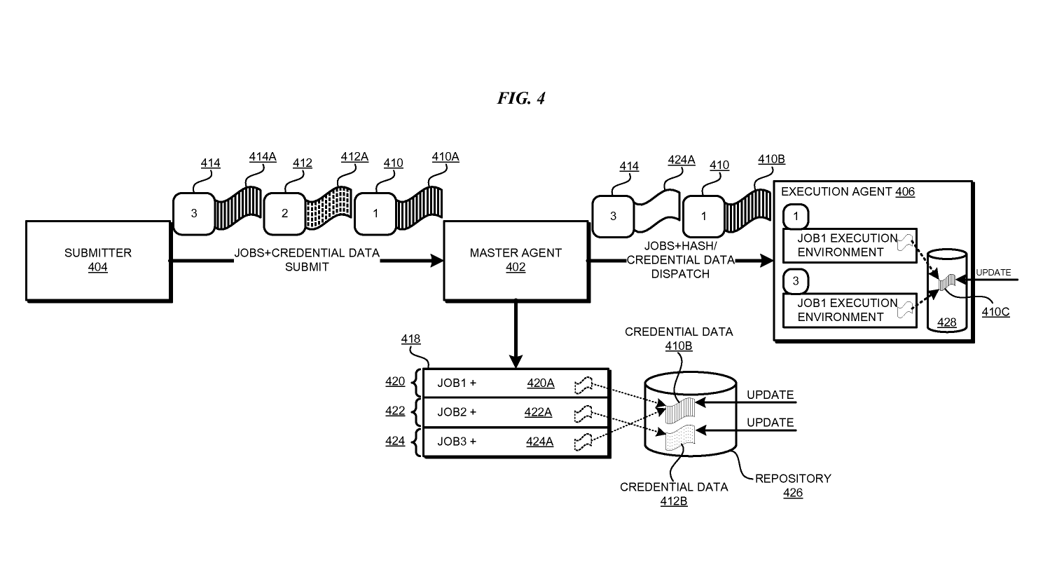

With reference to FIG. 4, this figure depicts a block diagram of a configuration for reducing job credentials management load in accordance with an illustrative embodiment. Master agent 402 is an example of master agent 302 in FIG. 3. Submitter 404 is an example of submitter 310 in a role in FIG. 3. Execution agent 406 is an example of execution agent 306 in FIG. 3.

Submitter 404 sends several jobs to master agent 402 to schedule for execution. For example, job 1 comprises job specification 410 and credential data 410A to execute the job. Similarly, job 2 comprises job specification 412 and credential data 412A to execute the job, and job 3 comprises job specification 414 and credential data 414A to execute the job.

Assume that jobs 1 and 3 require same authorizations to execute, and consequently use the same credential data. In other words, credential data 410A and 414A are the same. Job 2 requires different authorizations to execute, and consequently, credential data 412A is different from credential data 410A (and 414A). Further assume that job 1 is submitted first, followed by job 2, and followed by job 3.

Master agent receives job 1 and saves specification 410 in queue 418 at row 420. Master agent 402 determines that credential data 410A does not exist in repository 426, such as due to credential data 410A not having not been received with a previous job, or previously stored credential data 410A has been purged due to zero use count.

As a result of not finding credential data 410A in repository 426, master agent 402 saves credential data 410A in repository 426 as credential data 410B. Master agent 402 saves reference 420A to credential data 410B with job 1's specification in row 420. Similarly, master agent receives job 2, saves specification 412 in row 422 of queue 418, and saves new credential data 412A in repository 426 as credential data 412B. Master agent 402 saves reference 422A to credential data 412B with job 2's specification in row 422.

When master agent receives job 3, master agent 402 compares credential data 412B with credential data 414A and determines that credential data 414A is the same as credential data 410B. In one embodiment, master agent 402 also saves a hash value (not shown) of credential data 410A when saving credential data 410B, and uses the saved hash value for the comparison. In another embodiment, master agent 402 computes a hash value of credential data 410B and credential 414A as needed for comparison. The hash values can be computed using any suitable hashing algorithm.

Accordingly, master agent 402 saves specification 414 in row 424 of queue 418, but does not save credential data 414A in repository 426. Instead, master agent 402 notes reference 424A in row 424 where reference 424A points to credential data 410B. In one embodiment, reference 424A is the hash value of credential data 410B.

Operating in this manner, master agent 402 does not have to manage the credentials on a job-by-job basis for each of jobs 1, 2, and 3, but only manage two credentials, such as by updating credentials 410B and 412B in repository 426. In a large data processing environment managing tens of millions of jobs, such reduction in number of credentials managed during the lifecycle of jobs can significantly reduce the credentials management related workload and network traffic.

In one embodiment, a job is dispatched from queue 418 according to the resource availability in a node selected for the job's execution. Assume that master agent 402 schedules jobs 1 and 3 on the node where execution agent 406 is operating. In a manner described elsewhere in this disclosure, master agent 402 determines that execution agent 406 does not have access to credential data of job 1. Accordingly, master agent 402 dispatches job 1 to execution agent 406 by sending job 1 specification 410 and saved credential data 410B to execution agent 406. Having sent job 1 with credential data 410B, master agent 402 determines that execution agent 406 now has access to credential data of job 3. Accordingly, master agent 402 dispatches job 3 to execution agent 406 by sending job 3 specification 414 and reference 424A to execution agent 406.

In one embodiment, execution agent 406 receives job 1 from master agent 402. Execution agent 406 determines that credential data 410B is not available in repository 428, and saves credential data 410B as credential data 410C.

Upon receiving reference 424A with job 3, execution agent 406 references credential data 410C for executing job 3. In one embodiment, repositories 426 and 428 may be the same, and commonly used by master agent 402 and execution agent 406. In such an embodiment, reference 424A can be a pointer or any other reference to credential data 410B stored in repository 426.

In another embodiment, where repositories 426 and 428 are distinct, reference 424A is a hash value that corresponds to credential data 410B. When execution agent 406 receives a hash value in reference 424A, execution agent 406 compares the hash value of reference 424A with a hash value of saved credential data 410C and finds the two hash values to match. Execution agent 406 and master agent 402 use the same hash function in such an operation so that the comparison returns a match. Upon a match, execution agent 406 creates a reference to credential data 410C in repository 428 for executing job 3.

Operating in this manner, execution agent 406 does not have to manage the credentials on a job-by-job basis for each of jobs 1 and 3, but only manage one credential data, such as by updating credential 410C in repository 428.

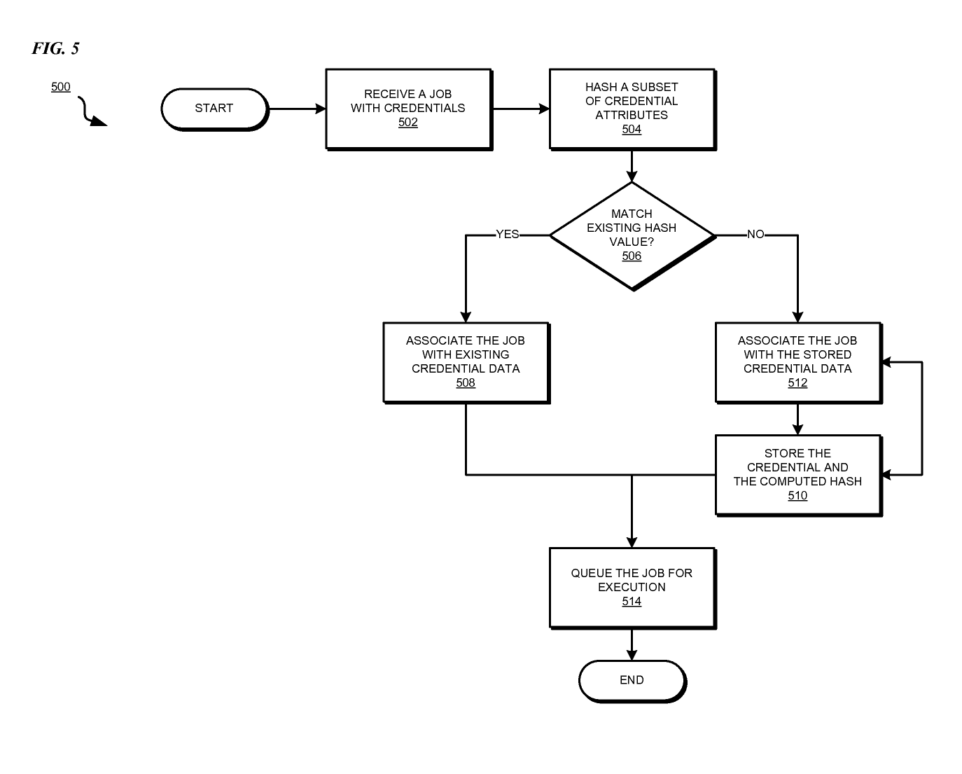

With reference to FIG. 5, this figure depicts a flowchart of an example process for reducing job credentials management load in accordance with an illustrative embodiment. Process 500 can be implemented in master agent 402 in FIG. 4.

The master agent receives a job with credential data sufficient to execute the job (block 502). The master agent hashes a subset of attributes of the credential data (block 504).

The master agent determines whether the hash value computed in block 504 matches a hash value of an existing credential data in a repository (block 506). If a match exists (“Yes” path of block 506), the master agent associates the job with the existing credential data (block 508). For example, in one embodiment, the master agent associates with the job a pointer to the existing credential data. In another example embodiment, the master agent associates the job with the hash value computed in block 504 and matched with the existing credential data.

If a match does not exist (“No” path of block 506), the master agent stores in the repository the credential data received in block 502 and, the hash value computed in block 504 (block 510). The master agent then associates the job with the newly stored credential data of block 510 (block 512).

The master agent queues the job for execution (block 514). The master agent ends process 500 thereafter, or repeats process 500 for another job.

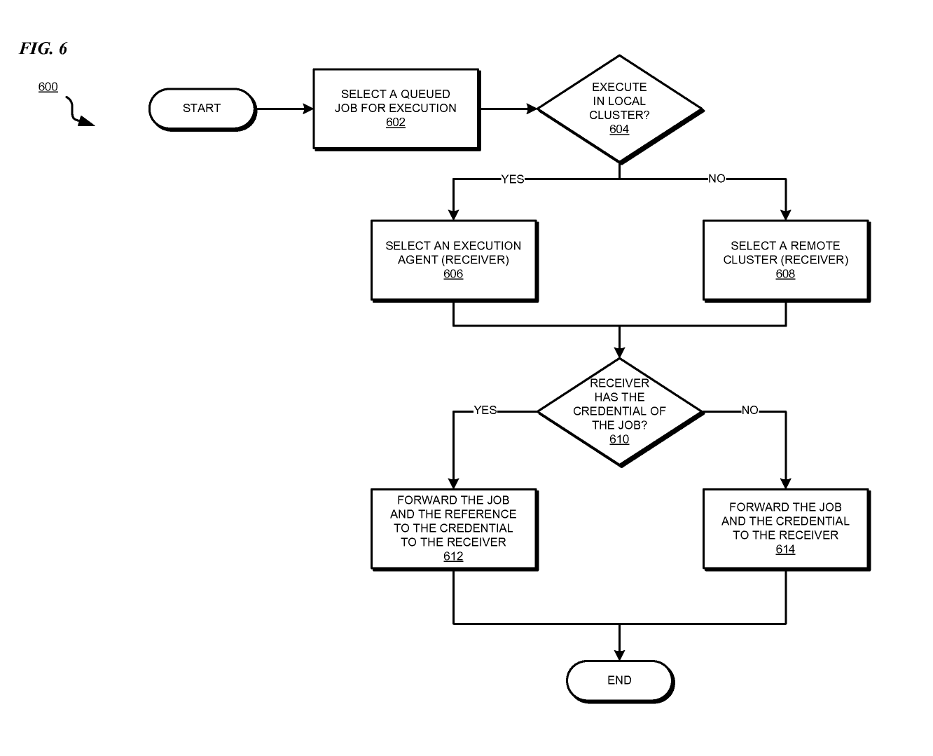

With reference to FIG. 6, this figure depicts a flowchart of another example process for reducing job credentials management load in accordance with an illustrative embodiment. Process 600 can be implemented in master agent 402 in FIG. 4.

The master agent selects a queued job for execution (block 602). The master agent determines whether to execute to job in the local cluster, i.e., using a node in the cluster where the master agent is operating (block 604). If the job is to be executed in the local cluster (“Yes” path of block 604), the master agent selects an execution agent to which to send the job for execution (block 606). If the job is not to be executed in the local cluster (“No” path of block 604), for example, when the job has to be forwarded to another master agent operating in another cluster, the master agent selects a remote cluster (block 608). The execution agent of block 606 and master agent of another cluster in block 608 are collectively referred to hereinafter as a receiver.

The master agent determines whether the receiver has the credential data of the job already (block 610). The determination whether another master agent has the credential data of the job can be made in a manner analogous to the manner of making the same determination with respect to an execution agent, as described elsewhere in this disclosure.

If the receiver has the credential data (“Yes” path of block 610), the master agent forwards the job and a reference to the credential data to the receiver (block 612). In one embodiment, the reference in the hash value of the credential data or a subset of attributes thereof. All entities using the hash values agree to use the same hash function on the same agreed subset of credential data attributes.

If the receiver does not have the credential data (“No” path of block 610), the master agent forwards the job and the credential data to the receiver (block 614). The master agent ends process 600 thereafter, or returns to block 602 to dispatch another job.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for reducing job credentials management load.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for reducing job credentials management load, the method comprising:
determining, at a first application using a processor and a memory, whether a credential data submitted with a job matches a second credential data stored in a repository, the credential data comprising a set of attributes;
associating, responsive to the credential data matching the second credential data, a reference to the second credential data with the job;
updating the second credential data to enable the job for execution; and
forwarding the job with the reference to a receiver application, wherein the reference provides the receiver application an authorization to execute the job.

2. The method of claim 1, further comprising:
selecting the receiver application, wherein the application operates to schedule jobs in a first cluster of data processing systems, and wherein the receiver application operates to schedule jobs in a second cluster of data processing systems.

3. The method of claim 1, wherein the credential data comprises an authorization attribute in a data file, and wherein the data file is forwardable from a first data processing system to a second data processing system such that the data file can be updated from both the first and the second data processing systems, and wherein the authorization attribute in the data file is determinative of whether the job can access a resource on a third data processing system during execution.

4. The method of claim 1, further comprising:
sending, to a credentials management system, a request to update the second credential data, wherein the application operates to schedule jobs in a first cluster of data processing systems, and wherein the credentials management system is operated by an entity unrelated to the operation of the first cluster.

5. The method of claim 1, further comprising:
computing a hash value of a subset of the set of attributes, wherein the determining comprises comparing the hash value with a second hash value computed from a corresponding subset of attributes of a set of attributes of the second credential data.

6. The method of claim 5, wherein the repository stores the second hash value.

7. The method of claim 1, further comprising:
receiving a previous job with the second credential data; and
saving the second credential data in the repository.

8. The method of claim 1, further comprising:
associating a use count indicator with the second credential data, wherein the use count indicator indicates a total number of jobs associated with the second credential data; and
incrementing, responsive to the credential data matching the second credential data, the use count.

9. The method of claim 8, further comprising:
decrementing the use count after an execution of one of (i) the previous job and (ii) the job, has completed.

10. The method of claim 1, wherein the reference is a hash value computed from a subset of attributes of a set of attributes of the second credential data.

11. A computer usable program product comprising a computer usable storage device including computer usable code for reducing job credentials management load, the computer usable code comprising:
computer usable code for determining, at a first application using a processor and a memory, whether a credential data submitted with a job matches a second credential data stored in a repository, the credential data comprising a set of attributes;
computer usable code for associating, responsive to the credential data matching the second credential data, a reference to the second credential data with the job;
computer usable code for updating the second credential data to enable the job for execution; and
computer usable code for forwarding the job with the reference to a receiver application, wherein the reference provides the receiver application an authorization to execute the job.

12. The computer usable program product of claim 11, further comprising:
computer usable code for selecting the receiver application, wherein the application operates to schedule jobs in a first cluster of data processing systems, and wherein the receiver application operates to schedule jobs in a second cluster of data processing systems.

13. The computer usable program product of claim 11, wherein the credential data comprises an authorization attribute in a data file, and wherein the data file is forwardable from a first data processing system to a second data processing system such that the data file can be updated from both the first and the second data processing systems, and wherein the authorization attribute in the data file is determinative of whether the job can access a resource on a third data processing system during execution.

14. The computer usable program product of claim 11, further comprising:
computer usable code for sending, to a credentials management system, a request to update the second credential data, wherein the application operates to schedule jobs in a first cluster of data processing systems, and wherein the credentials management system is operated by an entity unrelated to the operation of the first cluster.

15. The computer usable program product of claim 11, further comprising:
computer usable code for computing a hash value of a subset of the set of attributes, wherein the determining comprises comparing the hash value with a second hash value computed from a corresponding subset of attributes of a set of attributes of the second credential data.

16. The computer usable program product of claim 15, wherein the repository stores the second hash value.

17. The computer usable program product of claim 11, further comprising:
computer usable code for receiving a previous job with the second credential data; and
computer usable code for saving the second credential data in the repository.

18. The computer usable program product of claim 11, wherein the computer usable code is stored in a computer readable storage medium in a data processing system, and wherein the computer usable code is transferred over a network from a remote data processing system.

19. The computer usable program product of claim 11, wherein the computer usable code is stored in a computer readable storage medium in a server data processing system, and wherein the computer usable code is downloaded over a network to a remote data processing system for use in a computer readable storage medium associated with the remote data processing system.

20. A data processing system for reducing job credentials management load, the data processing system comprising:
a storage device including a storage medium, wherein the storage device stores computer usable program code; and
a processor, wherein the processor executes the computer usable program code, and wherein the computer usable program code comprises:
computer usable code for determining, at a first application using a processor and a memory, whether a credential data submitted with a job matches a second credential data stored in a repository, the credential data comprising a set of attributes;
computer usable code for associating, responsive to the credential data matching the second credential data, a reference to the second credential data with the job;
computer usable code for updating the second credential data to enable the job for execution; and
computer usable code for forwarding the job with the reference to a receiver application, wherein the reference provides the receiver application an authorization to execute the job.
